(19) United States
(12) Patent Application Publication
(10) Pub. No.: US 2026/0351008 A1
(43) Pub. Date: Nov. 5, 2026

(54) METHOD AND DEVICE FOR RECOGNIZING A LINE IN A CAMERA IMAGE FOR A MACHINE OR A TRANSMITTING SYSTEM, AND RECOGNITION SYSTEM FOR A MACHINE OR A TRANSMITTING SYSTEM

(71) Applicant: Robert Bosch GmbH, Stuttgart (DE)

(72) Inventors: Azhar Sultan, Tunbridge Wells (GB); Joel Janai, Leonberg (DE); Tamas Kapelner, Hildesheim (DE); Thomas Wenzel, Hamburg (DE)

(21) Appl. No.: 19/100,146

(22) PCT Filed: Aug. 31, 2023
(86) PCT No.: PCT/EP2023/073873

§ 371 Date: Jan. 31, 2025

(30) Foreign Application Priority Data
Sep. 12, 2022 (DE) 10 2022 209 504.9

(51) Int. Cl. G06V 20/56; G06V 10/766

(52) U.S. Cl. CPC G06V 20/588; G06V 10/766

(57) ABSTRACT

A method for recognizing a line in a camera image for a machine. The method includes a reading step, a recognizing step, and a generating step. In the reading step, a camera signal is read from an interface to a camera, the camera signal representing the camera image of the camera. In the recognizing step, a presence of the line in the camera image is recognized using at least one anchor having at least one base anchor point. In the generating step, a line regression of the line is generated using at least the base anchor point, the line regression having a first regression point which was shifted relative to the base anchor point and having at least one additional regression point which was generated relative to a previously generated regression point, in order to recognize the line.

### FIELD

The present invention relates to a device or a method for recognizing a line in a camera image for a machine or a transmitting system. The present invention also includes a computer program.

For example, driving assistance systems utilize lane recognition for a lane assist.

### SUMMARY

In light of this, the approach of the present invention provides a method for recognizing a line in a camera image for a machine or a transmitting system, a device that uses this method, a corresponding computer program, and a recognition system for a machine or a transmitting system. Advantageous developments and improvements of the method of the present invention are made possible by the measures disclosed herein.

Advantages that can be achieved with the presented approach of the present invention include that a particularly uniform prediction of a line is made possible.

A method for recognizing a line in a camera image for a machine or a transmitting system is presented. According to an example embodiment of the present invention, the method comprises a reading step, a recognizing step, and a generating step. In the reading step, a camera signal is read from an interface to a camera, the camera signal representing the camera image of the camera. In the recognizing step, a presence of the line in the camera image is recognized using at least one anchor, according to one embodiment using multiple anchors each having at least one base anchor point. In the generating step, a line regression of the line is generated using at least the base anchor point, the line regression having a first regression point which was shifted relative to the base anchor point and having at least one additional regression point which was generated relative to a previously generated regression point, in order to recognize the line.

This method may, for example, be implemented in software or hardware or in a mixed form of software and hardware, for example in a control unit.

According to an example embodiment of the present invention, the machine may be a fully or partially computer-controlled machine, for example a vehicle. The transmitting system may be a system for transmitting information, such as a monitoring system, or a medical system, for example an imaging system. The camera may be a vehicle camera, for example a vehicle camera of an environment detection system of the vehicle. In the recognizing step, a grid may, for example, be placed over the camera image, and the presence of the line may be recognized if the line is recognized in at least one cell of the grid. In the recognizing step, a recognized object may, for example, be classified, for example using a feature extractor, in order to recognize the line. The line may represent a road marking or an edge of an object. For example, the line may represent a portion of a lane. The anchor(s) may have a template or a pattern that is searched for in the camera image. For example, different anchors may be used to recognize different lines in the camera image. In the generating step, the line regression that compensates for an offset may be generated. For example, in the generating step, the line regression may be generated if the base anchor point was recognized in a cell center of a cell of the grid and/or on a line. For example, in the generating step, the line regression in which the first regression point was shifted relative to the base anchor point on an x-axis and the first additional regression point was generated so as to be shifted relative to the first regression point on the x-axis and a y-axis perpendicular to the x-axis, and subsequent additional regression points were generated so as to be shifted relative to the respectively previously generated regression point on the x-axis and the y-axis, may be generated in order to recognize the line. Such a method makes the line regression, which may also be referred to as a regression representation, in lane recognition possible by predicting the offsets/deviation of each point along the line/lane relative to the previous point and not relative to the anchor. This advantageously results in a particularly uniform prediction of the line. The prediction describes the offset, in the image coordinates, that must be applied to the anchor in order to fit the line into the image.

According to an example embodiment of the present invention, the method may furthermore comprise an outputting step, in which a control signal for controlling a function of the machine, in particular of a vehicle, or of the transmitting system is output using the line regression. This makes it possible to use the line regression, which can predict a course of the line, for example in the form of a lane, to control a vehicle, for example in order to keep the vehicle within the lane.

According to one example embodiment of the present invention, in the recognizing step, the line can be recognized in an edge region of the camera image using the at least one anchor and/or in a cell of the camera image, divided into a plurality of cells, using the anchor of the respective cell. For example, in the recognizing step, the line may be recognized in a cell center of the cell. In this way, the edge region of the camera image can be search quickly and simply for lines in individual cells.

According to an example embodiment of the present invention, it is furthermore advantageous if, according to one embodiment, in the recognizing step, the line in the camera image is recognized if at least the base anchor point of the anchor passes through the line. However, in the recognizing step, the line in the camera image may also be recognized if only the base anchor point passes through the line or passes near the line. An anchorless method in which only the base anchor point is necessary as an anchor may thus be used for recognizing the line.

Alternatively, according to an example embodiment of the present invention, in the recognizing step, the line in the camera image may be recognized if the entire anchor passes through the line or near the line. An anchor-based method may thus be used for recognizing the line. The term “entire anchor” is understood to mean an anchor having more than one base anchor point, for example a line-shaped anchor.

The term “near” is understood to mean a deviation of a few pixels, for example.

The approach presented here according to the present invention furthermore provides a device which is designed to carry out, control or implement the steps of a variant of a method presented here, in corresponding units. The object of the present invention can also be achieved quickly and efficiently by this embodiment variant of the approach in the form of a device.

According to an example embodiment of the present invention, for this purpose, the device may comprise at least one computing unit for processing signals or data, at least one memory unit for storing signals or data, at least one interface to a sensor or to an actuator for reading sensor signals from the sensor or for outputting data signals or control signals to the actuator, and/or at least one communication interface for reading or outputting data embedded in a communication protocol. The computing unit may, for example, be a signal processor, a microcontroller, or the like, wherein the memory unit may be a flash memory, an EEPROM, or a magnetic memory unit. The communication interface may be designed to read or output data in a wireless and/or wired manner, wherein a communication interface capable of reading or outputting wired data may, for example, electrically or optically read these data from a corresponding data transmission line or output these data into a corresponding data transmission line.

Here, according to an example embodiment of the present invention, a device may be understood to be an electrical device that processes sensor signals and, on the basis thereof, outputs control signals and/or data signals. The device may have an interface in the form of hardware and/or software. In the case of a hardware design, the interfaces may, for example, be part of a so-called system ASIC, which contains various functions of the device. However, it is also possible that the interfaces are separate integrated circuits or consist at least in part of discrete components. In the case of a software design, the interfaces may be software modules that are, for example, present on a microcontroller in addition to other software modules.

A computer program product or a computer program comprising program code that can be stored on a machine-readable carrier or storage medium, such as a semiconductor memory, a hard disk memory or an optical memory, and can be used to carry out, implement and/or control the steps of the method according to one of the above-described embodiments of the present invention is advantageous as well, in particular when the program product or program is executed on a computer or a device.

A recognition system for a machine or a transmitting system comprises the device described above and a camera for providing the camera signal. Such a recognition system may be used as a comprehensive system for automated recognition of lines such as lanes, wherein lines such as lanes can be predicted particularly uniformly thanks to the device. The recognition system may be part of a driving assistance system for a vehicle.

Exemplary embodiments of the present invention disclosed herein are shown in the figures and explained in more detail in the following description.

### BRIEF DESCRIPTION OF THE DRAWINGS

FIG. 1 shows a schematic illustration of a machine comprising a device according to an exemplary embodiment for recognizing a line in a camera image, according to the present invention.

FIG. 2 shows a schematic illustration of a line regression generated using a generating unit of a device according to an exemplary embodiment of the present invention.

FIG. 3 shows a schematic illustration of a camera image for use with a device according to an exemplary embodiment of the present invention.

FIG. 4 shows a flowchart of a method according to an exemplary embodiment of the present invention for recognizing a line in a camera image for a machine or a transmitting system.

### DETAILED DESCRIPTION OF EXAMPLE EMBODIMENTS

In the following description of favorable exemplary embodiments of the present invention, identical or similar reference signs are used for the elements shown in the various figures and acting similarly, wherein a repeated description of these elements is dispensed with.

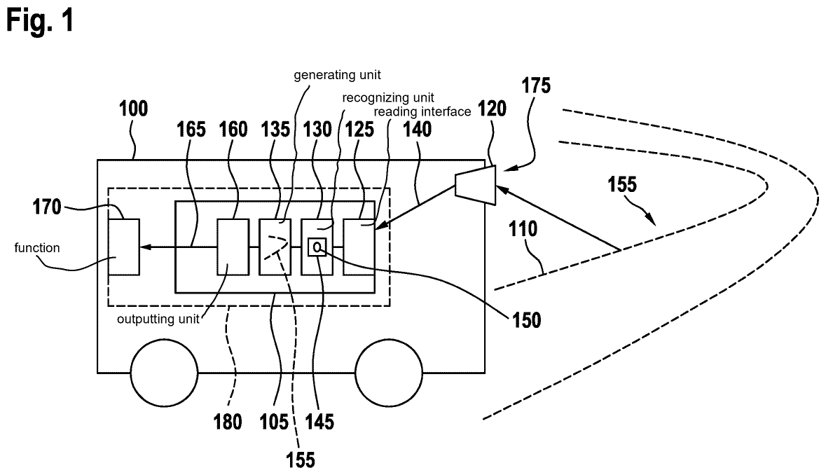

FIG. 1 shows a schematic illustration of a machine 100 comprising a device 105 according to an exemplary embodiment for recognizing a line 110 in a camera image.

Only by way of example, the device 105 according to this exemplary embodiment is arranged on or in the machine 100, which here takes the form of a vehicle by way of example. According to an exemplary embodiment, the device 105 is implemented into a control unit of the machine 100. According to this exemplary embodiment, the machine 100 furthermore comprises a camera 120, which here, by way of example, takes the form of an environment detection camera for detecting an environment of the machine 100. According to an alternative exemplary embodiment, the device 105 can accordingly be used with a transmitting system.

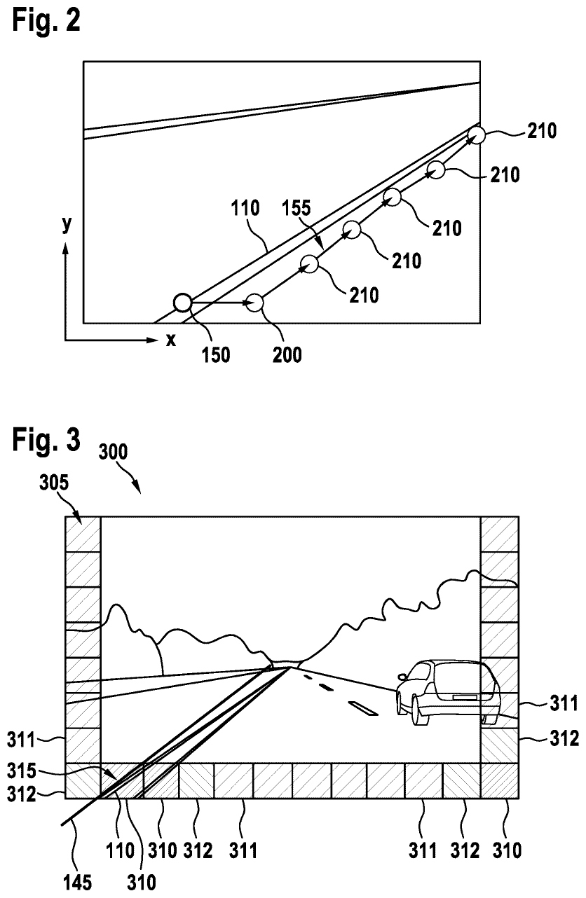

The device 105 comprises a reading interface 125, a recognizing unit 130, and a generating unit 135. The reading interface 125 is designed to read a camera signal 140 from an interface to the camera 120, the camera signal 140 representing the camera image of the camera 120. The recognizing unit 130 is designed to recognize a presence of the line 110 in the camera image using an anchor 145 having at least one base anchor point 150. The generating unit 135 is designed to generate a line regression 155 of the line 110 using at least the base anchor point 150, the line regression 155 having a first regression point which was shifted relative to the base anchor point and having a second regression point which was generated relative to the first regression point and, according to the second regression point, having at least one additional regression point which was generated relative to a previously generated regression point, in order to recognize the line 110. A more detailed illustration of the line regression 155 is shown in FIG. 2.

According to this exemplary embodiment, the camera 120 takes the form of a vehicle camera, for example a vehicle camera of an environment detection system of the vehicle. The anchor 145 comprises a template or a pattern that is searched for in the camera image by the recognizing unit 130 in order to recognize the line 110. The generating unit 135 is designed according to this exemplary embodiment to generate the line regression 155 that compensates for an offset. The device 105 presented here makes the line regression 155, which may also be referred to as a regression representation, in lane recognition possible by predicting the offsets/deviations of each point along the line 110, which is a lane according to this exemplary embodiment, relative to the previous point and not relative to the anchor 145. This advantageously results in a particularly uniform prediction of the line 110, see also FIG. 2.

Optionally, the device 105 according to this exemplary embodiment furthermore comprises an outputting unit 160 designed to output, using the line regression 155, a control signal 165 for controlling a function 170 of the machine 100, here of the vehicle, or alternatively of the transmitting system. This makes it possible to use the line regression 155, which can predict a course of the line 110, for example in the form of a lane, to control the machine 100, for example in order to keep the vehicle within the lane.

According to this exemplary embodiment, the recognizing unit 130 is designed to recognize the line 110 in an edge region of the camera image and/or in a cell of the camera image, divided into a plurality of cells, using the anchor 145, see also FIG. 3 in this respect.

According to this exemplary embodiment, the recognizing unit 130 is designed to recognize the line 110 in the camera image if at least the base anchor point 150 of the anchor 145 passes through the line 110. Or the recognizing unit 130 is designed according to an exemplary embodiment to recognize the line 110 in the camera image if only the base anchor point 150 passes through the line 110 or passes near the line 110. According to an exemplary embodiment, an anchorless method in which only the base anchor point 150 is necessary as an anchor 145 is thus used for recognizing the line 110. According to an alternative exemplary embodiment, the recognizing unit 130 is designed to recognize the line 110 in the camera image if the entire anchor passes through the line 110 or passes near the line 110. According to another exemplary embodiment, an anchor-based method is thus used for recognizing the line 110. The term “entire anchor” 145 is understood to mean an anchor 145 having more than the base anchor point 150, for example a line-shaped anchor. The term “near” is understood to mean a deviation of at most 5 millimeters, for example.

Together with the camera 120, the device 105 presented here may also be referred to as a recognition system 175. The recognition system 175 according to an exemplary embodiment is part of a driving assistance system 180 of the vehicle.

The device 105 presented here makes delta regression/feedback possible for lane recognition.

Traditionally, deep object detectors used in computer vision are based on a concept called anchor, i.e., so-called prior boxes are used as prototypes for the recognition. In this context, the detectors predict shifts/offsets of the boxes relative to the respective anchors. Lane recognition is a special case of object recognition in which the objects are characterized by series of lines rather than by boxes. In addition to traditional instance segmentation methods, anchor-based object recognition methods are therefore also used.

The device 105 presented here changes the regression representation of the lane recognition task by predicting the offsets/deviation of each point along the lane relative to the previous point and not relative to the anchor 145. The approach presented here may be formulated as both an anchor-based and an anchorless method. In both cases, only the base anchor point 150 of the anchors 145 is used (cell centers), the difference is only in the adaptation step.

This formulation results in a more uniform prediction of the line 110 in comparison to an also possible regression representation in which all regression points are generated relative to the anchor. Since the anchors 145 become superfluous, this also results in a smaller neural network.

The device 105 presented here works with data of the following types, which are obtained according to an exemplary embodiment by receiving digital images and/or videos, in order to calculate the control signal 165 for controlling a physical system, such as
a computer-controlled machine 100, such as a robot, a vehicle, a household appliance, an electric tool, a manufacturing machine, a personal assistant, or an access control system, or
a system for transmitting information, such as a monitoring system, or a medical system, for example an imaging system.
   The device 105 does so by recognizing the presence of objects in the sensor data, in particular lanes or other types of line-based road markings.

The device 105 works with images; an image acquisition in the form of the camera image must therefore be present, which serves as an input for the approach presented here.

FIG. 2 shows a schematic illustration of a line regression 155 generated using a generating unit of a device according to an exemplary embodiment. The latter may be the device described in FIG. 1.

The line regression 155 has the first regression point 200, which was shifted relative to the base anchor point 150 of the anchor. Starting from the first regression point 200, additional regression points 210 were generated, each relative to a directly previously generated regression point 200, 210. For example, the generating unit according to this exemplary embodiment is designed to generate the line regression 155 in which the first regression point 200 was shifted relative to the base anchor point 150 on an x-axis, the first additional regression point 210 was generated so as to be shifted relative to the previously generated first regression point 200 on the x-axis and the y-axis, and the subsequent additional regression points 210 were generated so as to be shifted relative to the respectively previously generated additional regression point 210 on the x-axis and the y-axis, in order to recognize the line 110. According to this exemplary embodiment, the line regression 155 has at least five additional regression points 210, which were each generated so as to be shifted relative to the previously generated regression point 200, 210 on the x-axis and the y-axis.

With conventional regressions, the coordinates are predicted relative to the anchors, i.e., the prediction describes an offset, in the image coordinates, that must be applied to the anchor in order to fit the line into the image only on the x-axis. Unlike the conventional regression method, the approach presented here is realized in such a way that not only are the x coordinates predicted but the y coordinates are also not fixed. Thus, the approach presented here differs from conventional regression methods in that the references for the regression are points 150, 200, 210 rather than lines, and that, for each cell, see FIG. 3, through which a line on the image was recognized, the regression coordinates are predicted relative to the previous coordinate. This means that the prediction for the first point 200 in the line is relative to the base anchor point 150, for the first additional point 210 relative to the first point 200, and so forth. In contrast to conventional approaches, this regression is formulated by predicting not only the x coordinate but also the y coordinate.

The approach described here can be formulated in two ways, depending on how the classification goal is chosen.

On the one hand, an anchorless method can be realized in which only the base anchor points 150 are used for both the line regression 155 and the classification. This means that a line 110 in the form of a ground-truth line matches an anchor if it passes through or near its base anchor point 150, and that there is no anchor line “matching” a ground-truth line.

On the other hand, an anchor-based method can be realized in which only the base anchor points 150 are used for the line regression 155, but the entire anchor with more than one base anchor point 150 is used for the classification. This means that a line 110 in the form of a ground-truth line is matched to an anchor if the similarity between the anchor and the line 110 is high enough.

Unlike in the predictions of the regression which describes a linear shift relative to a line-shaped anchor and the application of the offset to the anchor coordinates results in a line prediction, the present approach changes this to the effect that the anchor is only a point 150 and not a line, and the predictions describe a shift relative to the previous point, as opposed to the corresponding anchor point. The line regression 155 as a whole thus does not represent a straight line.

FIG. 3 shows a schematic illustration of a camera image 300 for use with a device according to an exemplary embodiment. This device may be the device described in FIG. 1 or 2.

The recognizing unit of the device is designed according to this exemplary embodiment to place a grid 305 over the camera image 300, and to recognize the presence of the line 110 if the line 110 is recognized in at least one cell 310, 311, 312 of the grid 305. The recognizing unit is designed according to this exemplary embodiment to classify a recognized object, for example using a feature extractor, in order to recognize the line 110. The line 110 represents a road marking according to this exemplary embodiment or an edge of an object according to an alternative exemplary embodiment. For example, the line 110 according to this exemplary embodiment represents a portion of a lane. For example, the generating unit is designed according to this exemplary embodiment to generate the line regression if the base anchor point was recognized on a line 110 in a cell center 315 of a cell 310, 311, 312 of the grid 305.

In summary, according to an exemplary embodiment, according to the anchor 145 in the cell 310 or only the base anchor point of the anchor 145 in the cell 310, additional anchors are defined in the cells 310, 311, 312 along the borders of the image 300, and the classification output predicts for each cell 310, 311, 312 whether or not the cell 310, 311, 312 contains a corresponding line 110, for example a lane, which is similar to one of the anchors 145 in this cell 310, 311, 312. For the sake of clarity, FIG. 3 shows only a corresponding anchor 145 through one of the cells 310.

In other words, a network according to an exemplary embodiment predicts for each cell 310, 311, 312 whether, in the cell 310, 311, 312, there is a line 110 that is similar to an anchor 145 assigned to the respective cell 310, 311, 312. According to this exemplary embodiment, on two opposing image sides of the camera image 300 along the edge, the grid 305 in each case comprises eight uniformly sized cells 310, 311, 312 arranged one above the other. Along the edge of a bottom of the camera image 300, the grid 305 according to this exemplary embodiment comprises twelve uniformly sized cells 310, 311, 312 arranged next to one another. Cells 310 represent a positive prediction of a line 110, cells 311 represent a negative prediction, and cells 312 represent a border case.

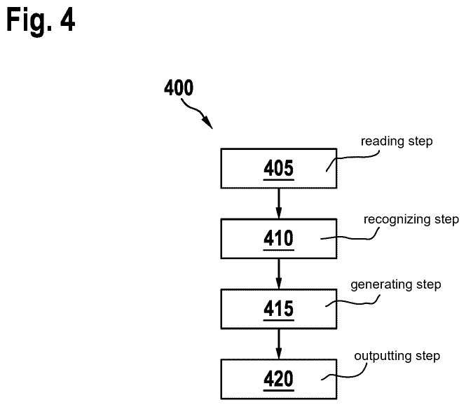

FIG. 4 shows a flowchart of a method 400 according to an exemplary embodiment for recognizing a line in a camera image for a machine or a transmitting system. This method may be a method 400 that can be performed by one of the devices described with reference to the above-described figures.

The method 400 comprises a reading step 405, a recognizing step 410, and a generating step 415. In the reading step 405, a camera signal is read from an interface to a camera, the camera signal representing the camera image of the camera. In the recognizing step 410, a presence of the line in the camera image is recognized using an anchor having at least one base anchor point. In the generating step 415, a line regression of the line is generated using at least the base anchor point, the line regression having a first regression point which was shifted relative to the base anchor point and having at least one additional regression point which was generated relative to a previously generated regression point, in order to recognize the line.

If multiple anchors are present, they may be used for recognizing the line or for recognizing different lines in a corresponding manner.

Optionally, the method 400 according to this exemplary embodiment furthermore comprises an outputting step 420. In the outputting step 420, a control signal for controlling a function of the machine, in particular of a vehicle, or of the transmitting system is output using the line regression.

1-10. (canceled)

11. A method for recognizing a line in a camera image for a machine or for a transmitting system, the method comprising the following steps:
reading a camera signal from an interface to a camera, the camera signal representing the camera image of the camera;
recognizing a presence of the line in the camera image using at least one anchor having at least one base anchor point; and
generating a line regression of the line using at least the base anchor point, the line regression having a first regression point which was shifted relative to the base anchor point and having at least one additional regression point which was generated relative to a previously generated regression point, in order to recognize the line.

12. The method according to claim 11, further comprising:
outputting a control signal for controlling a function of the machine or of the transmitting system, using the line regression.

13. The method according to claim 12, wherein the control signal is output to the machine, wherein the machine is a vehicle.

14. The method according to claim 11, wherein, in the recognizing step, the line is recognized: (i) in an edge region of the camera image using the at least one anchor and/or (ii) in a respective cell of the camera image, divided into a plurality of cells, using an anchor of the respective cell.

15. The method according to claim 11, wherein, in the recognizing step, the line in the camera image is recognized when at least the base anchor point of the anchor passes through the line.

16. The method according to claim 15, wherein, in the recognizing step, the line in the camera image is recognized when the entire anchor passes through the line.

17. The method according to claim 11, wherein the line represents a road marking or an edge of an object.

18. A device configured to recognize a line in a camera image for a machine or for a transmitting system, the device configured to perform or control the following steps:
reading a camera signal from an interface to a camera, the camera signal representing the camera image of the camera;
recognizing a presence of the line in the camera image using at least one anchor having at least one base anchor point; and
generating a line regression of the line using at least the base anchor point, the line regression having a first regression point which was shifted relative to the base anchor point and having at least one additional regression point which was generated relative to a previously generated regression point, in order to recognize the line.

19. A recognition system for a machine or a transmitting system, the recognition system comprising:
a camera configured to provide a camera signal; and
a device configured to recognize a line in a camera image, the device configured to perform or control the following steps:
reading the camera signal from an interface to the camera, the camera signal representing the camera image of the camera;
recognizing a presence of the line in the camera image using at least one anchor having at least one base anchor point; and
generating a line regression of the line using at least the base anchor point, the line regression having a first regression point which was shifted relative to the base anchor point and having at least one additional regression point which was generated relative to a previously generated regression point, in order to recognize the line.

20. A non-transitory machine-readable storage medium on which is stored a computer program for recognizing a line in a camera image for a machine or for a transmitting system, the computer program, when executed by a computer, causing the computer to perform or control the following steps:
reading a camera signal from an interface to a camera, the camera signal representing the camera image of the camera;
recognizing a presence of the line in the camera image using at least one anchor having at least one base anchor point; and
generating a line regression of the line using at least the base anchor point, the line regression having a first regression point which was shifted relative to the base anchor point and having at least one additional regression point which was generated relative to a previously generated regression point, in order to recognize the line.
